(19) United States
(12) Patent Application Publication
(10) Pub. No.: US 2009/0246383 A1
(43) Pub. Date: Oct. 1, 2009

(54) Coating apparatus using items that roll

(75) Inventor: Linda M. Hatheway, Wichita, KS (US)

Correspondence Address: Linda M. Hatheway, 13813 W. Onewood Ct., Wichita, KS, 67235, US

(73) Assignee: Linda M. Hatheway

(21) Appl. No.: 12/079,387

(22) Filed: Mar. 26, 2008

(51) Int. Cl. B05D 5/00; B05C 13/02

(52) U.S. Cl. 427/280; 118/56

(57) ABSTRACT

“Marble It” is a craft box that is made of arylonitrile-butadien-styrene with a sliding clear cover made of polycarbonate or (PC). This box will enable a child to manipulate items that roll onto paper covered with paint.

### CROSS-REFERENCE TO RELATED APPLICATION

Apparatus For Forming Artistic Patterns U.S. Pat. No. 3,453,991 patented Jul. 8, 1969 has a receptacle including a slot means formed at the joiner of the receptacle bas and the upstanding wall thereof whereby a card adapted to receive color matter therein may be retained within the receptacle and disc means adapted to be inserted into said receptacle for cooperation with the color bearing card surface and having a handle element whereby said disc may be manipulated to smear said color matter to effect a design pattern on the card surface. This is a continuation of application Ser. No. 599-951, filed Dec. 7, 1966, and now abandoned. The forming of artistic patterns of varying designs was achieved by this device in which a motor spins or turns a board.

Squeezing of a color on the board during its spinning or turning results in the color spreading out due to centrifugal force created by the rotating board. However, this type of structure for forming artistic design creates several problems.
1. There is danger with the rotating board. This is particularly true with respect to young children, who may have their fingers caught or hit by the board. Thus, this limits the toy to children of an older age whereas the formation of accidental design patterns is particularly appealing to young children.
2. The rotating or spinning board can be relatively high in cost.

My invention satisfactorily overcomes the problems mentioned above by;
(a) It is safer as the items that roll are contained within the box.
(b) The box offers the possibility of variations by using anything that rolls.
(c) It is manually operated, encouraging physical interaction.
(d) Adding maze templates FIG. 4 & FIG. 5, enhance eye hand coordination and cognitive development.
(e) Allows children to work as partners, reinforces the benefits of teamwork.
(f) As the child identifies and discusses the rolling items, language development is enchanced.
(g) The basic principles of math and science are introduced as the child counts and observes the items that roll.

### BACKGROUND OF INVENTION

### FIELD OF INVENTION

This invention relates to an art technique making it possible to reproduce on a blank sheet of paper, multi-colored artwork.

### SUBMITTED DRAWINGS

FIG. 1 Sliding Cover Version

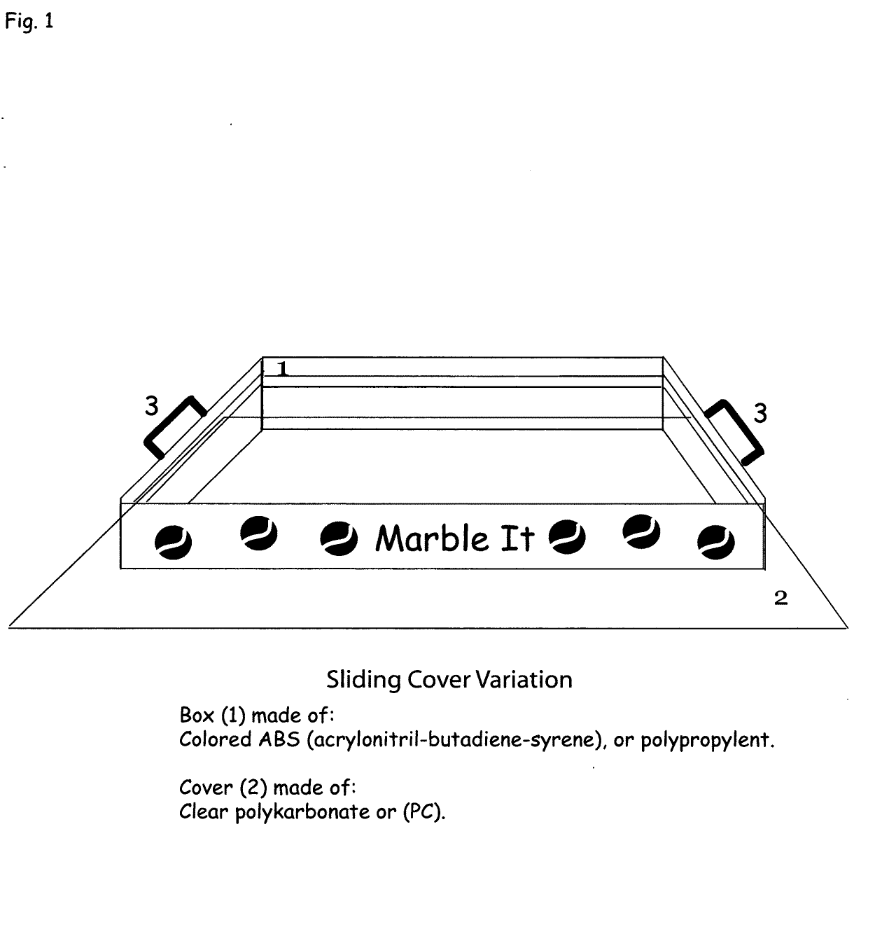

Box 1 of colored ABS (arylonitrile-butadien-styrene) or polypropylene, contains a grove at the sides and back for cover 2 of clear polycarbonate or (PC) to slide in and out of the box 1. On the outside handles 3 are attached.

FIG. 2 Hinge & Latch Closure Version

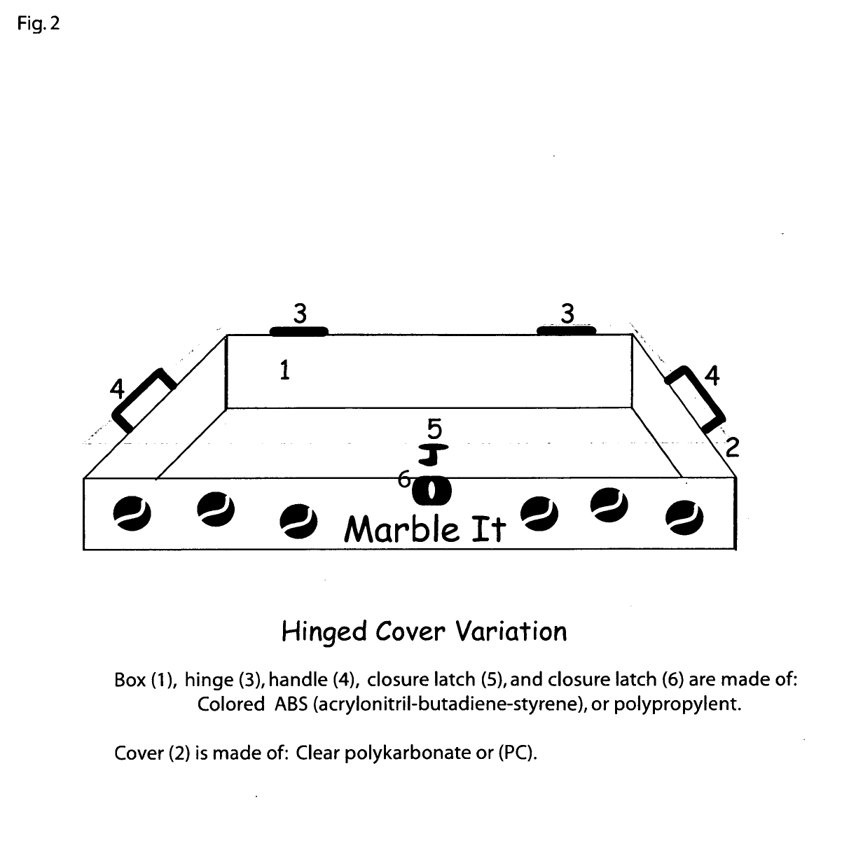

Box 1 and hook closure 6 are of colored ABS (arlonitrile-butadien-styrene) or polypropylene. The cover 2 is attached to box 1 with colored ABS (arlonitrile-butadien-styrene) or polypropylene hinges and contains latch 5 of ABS (arlonitrile-butadien-styrene) or polypropylene for closure.

FIG. 3 Snap On Version

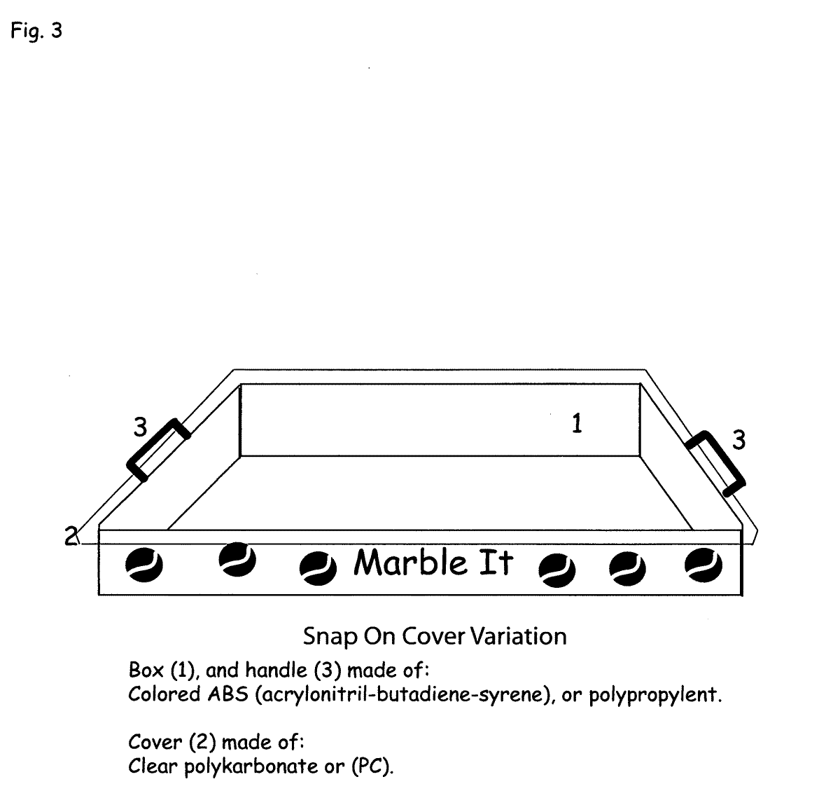

Box 1 of colored ABS (arlonitrile-butadien-styrene) or polypropylene has a snap on cover 2 of clear polycarbonate or (PC).

FIG. 4 Spiral Maze

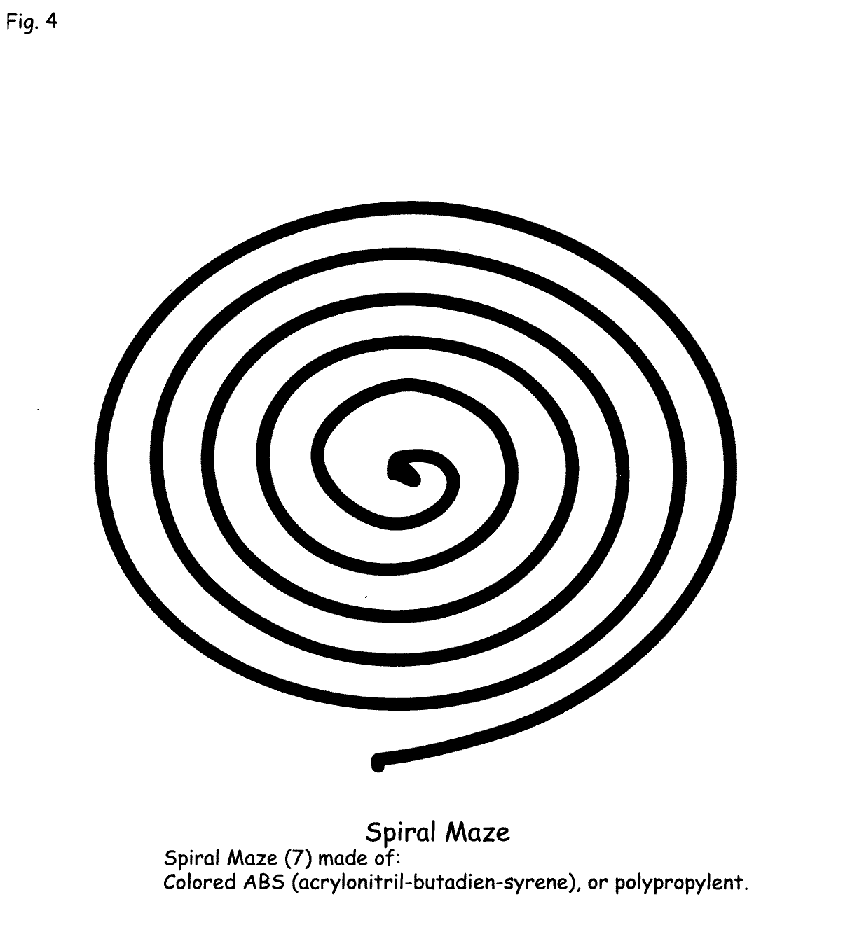

Spiral maze 7 of colored ABS (arlonitrile-butadien-styrene) or polypropylene can be placed into box 1 to manipulate the items that roll.

FIG. 5 Rectangular Maze

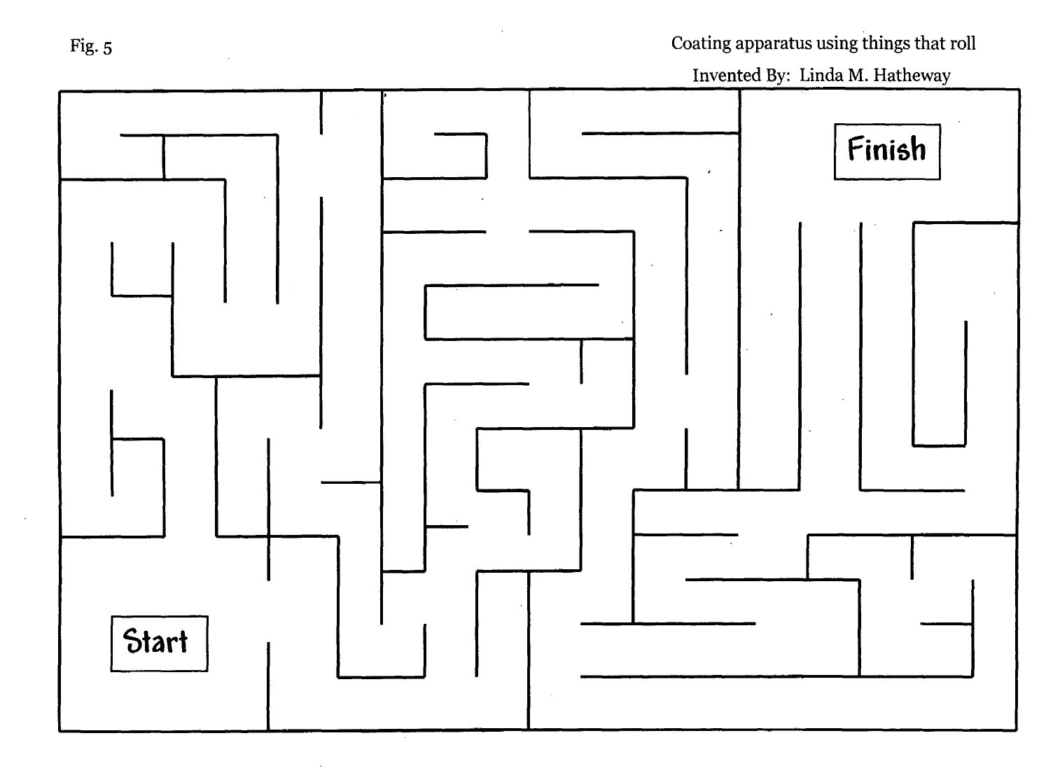

Rectangular maze 8 of colored ABS (arlonitrile-butadien-styrene) or polypropylene t can be placed into box I to manipulate the items that roll.

To use box 1, cover 2 is removed by sliding it in or out of the box, raising it, or snapping it onto the box. After opening the box, place paper, paint and items that roll into the box. Close the box by using appropriate closure method. Manipulate the rolling items across the paint onto the paper, creating unique designs. Many art projects can also be expanded from the finished artwork. Examples: decoupage, collage, clothing, and dinner ware. The projects are open to the imagination.

I claim:

1. An art technique for reproducing multi-colored artwork, comprising the steps of:
(a) placing paper into the box;
(b) adding the paint onto the paper;
(c) add marbles, or balls;
(d) manipulate the rolling items to create designs.

2. The box will consist of the following:
(a) 9″×13″×3″ polymer plastic box;
(b) box will have a grove around three of the sides;
(c) a clear polymer plastic cover will slide into the grove on the box.
